(19) United States
(12) Patent Application Publication
(10) Pub. No.: US 2018/0002001 A1
(43) Pub. Date: Jan. 4, 2018

(54) Water Helicopter

(71) Applicant: Carter L Daniel, SR., Brooklyn, MD (US)

(72) Inventor: Carter L Daniel, SR., Brooklyn, MD (US)

(21) Appl. No.: 15/199,568

(22) Filed: Jun. 30, 2016

(51) Int. Cl. B64C 25/54; B64C 27/08; B64C 1/14; B64C 25/10; B64C 29/00; B64C 27/26

(52) U.S. Cl. CPC B64C 25/54; B64C 29/0025; B64C 27/26; B64C 1/1423; B64C 25/10; B64C 27/08

(57) ABSTRACT

Disclosed herein is a water helicopter includes a fuselage, first and second fixed wings extending outwardly from left and right ends of the fuselage, first and second propellers disposed in a spaced apart configuration on a top surface of the fuselage, and a landing and float gear attached to a bottom surface of the fuselage for enabling landing of the water helicopter on water.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

The present disclosure relates generally to helicopters, and more particularly to helicopters capable of landing on water.

### BACKGROUND

A helicopter is a type of rotorcraft in which lift and thrust are supplied by rotors. This allows the helicopter to take-off and land vertically, to hover, and to fly forward, backward, and laterally. These attributes allow helicopters to be used in congested or isolated areas where fixed-wing aircraft and many forms of vertical take-off and landing aircraft cannot be performed.

In the event of accidents and calamities, when there is a need for rescue in water, it takes time to send a boat for rescue. A quicker rescue is required, which is possible only by air. For example, if for some reason, an aeroplane has crashed into water, people need to be rescued as soon as possible. So, an aircraft is required that can land on water and is capable of picking up lot of people, such as almost twenty people at time. There exists helicopters that are capable of picking up people from water, but they are limited to accommodating only two-three people at a time. Larger helicopters are capable of picking up people from land, but not on water.

In view of the above, there is a need for a helicopter/aircraft that overcomes the above-mentioned limitations of the existing systems, facilitates quicker rescue of large number of people from water bodies, and should be able to be used by Special and Military forces.

### SUMMARY

This Summary is provided to introduce a selection of concepts in a simplified form that are further described below in the Detailed Description. This Summary is not intended to identify key features or essential features of the claimed subject matter, nor it is intended to be used to limit the scope of the claimed subject matter.

In accordance with an embodiment of the present disclosure, a water helicopter is provided that includes a fuselage, first and second fixed wings extending outwardly from left and right ends of the fuselage, first and second propellers disposed in a spaced apart configuration on a top surface of the fuselage, and a landing and float gear attached to a bottom surface of the fuselage for enabling landing of the water helicopter on water.

In accordance with another embodiment of the present disclosure, a water helicopter is provided that includes a fuselage, first and second fixed wings extending outwardly from left and right ends of the fuselage, wherein the first and second fixed wings generate a lift due to a forward airspeed of the water helicopter, and shapes of the first and second fixed wings, first and second propellers disposed in a spaced apart configuration on a top surface of the fuselage, wherein the first and second propellers enable vertical ascending and descending of the water helicopter, and a landing and float gear attached to a bottom surface of the fuselage for enabling landing of the water helicopter on water.

It will be appreciated that features of the present disclosure are susceptible to being combined in various combinations without departing from the scope of the present disclosure as defined by the appended claims.

### BRIEF DESCRIPTION OF THE DRAWINGS

The foregoing summary, as well as the following Detailed Description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

Embodiments of the present disclosure will now be described, by way of example only, with reference to the following diagrams wherein:

FIG. 1 is a front perspective view of a water helicopter, in accordance with an embodiment of the present disclosure;

FIG. 2 is a top perspective view of the water helicopter of FIG. 1, in accordance with an embodiment of the present disclosure;

FIG. 3 is a top view of the water helicopter of FIG. 1, in accordance with an embodiment of the present disclosure; and

FIG. 4 is a side view of the water helicopter of FIG. 1, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

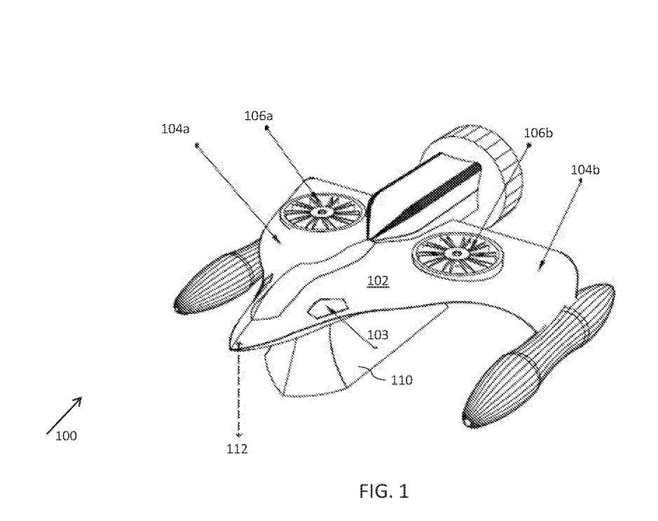

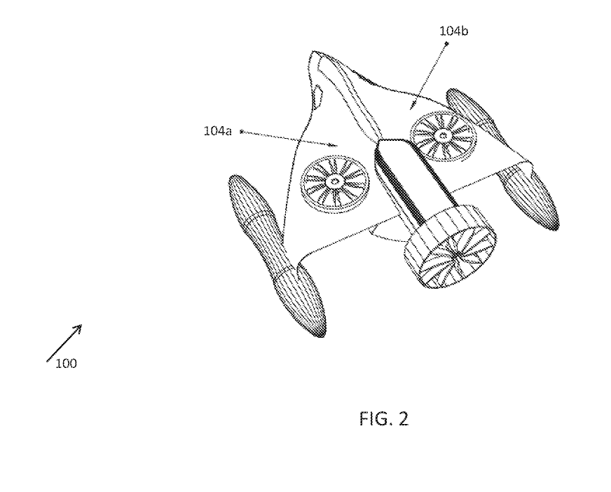

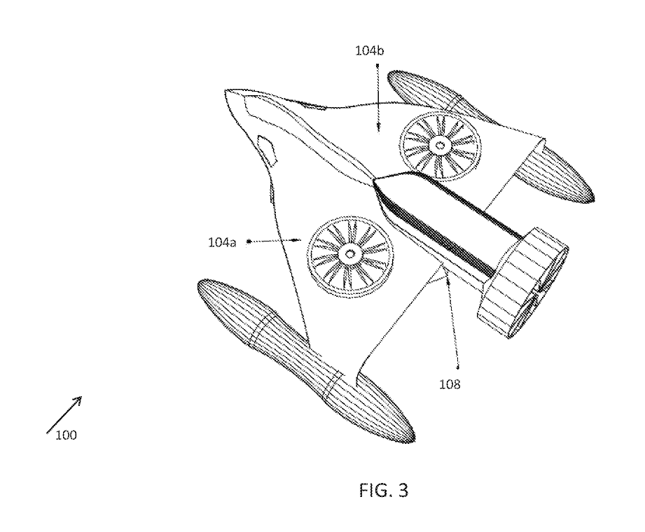

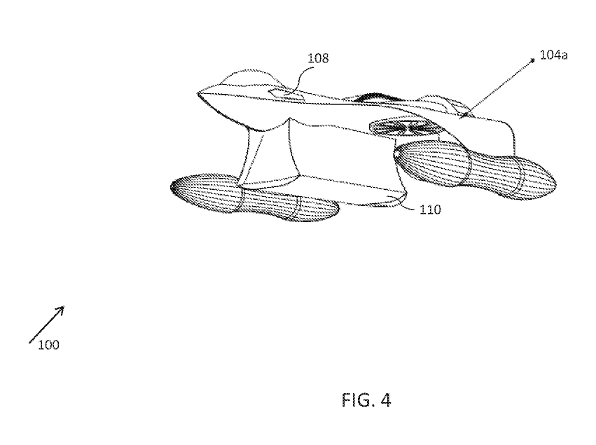

Referring particularly to the drawings, there is shown in FIGS. 1-4, the water helicopter 100 of this invention. The water helicopter 100 is composed generally of a fuselage 102 with an aerodynamic configuration, first and second fixed wings 104a and 104b extending outwardly from left and right ends of the fuselage 102, first and second propellers 106a and 106b disposed in a spaced apart configuration on a top surface of the fuselage 102, and landing and float gear 110.

The fuselage 102 is the main body section of the helicopter 100 that holds crew and passengers or cargo. The fuselage 102 also serves to position control and stabilization surfaces in specific relationships to lifting surfaces, required for aircraft stability and maneuverability. The fuselage 102 has a door 103 for enabling the crew and passengers to enter therein.

The helicopter 100 is capable of flight using the first and second fixed wings 104a and 104b, which generate lift caused by the vehicle's forward airspeed and the shape of the first and second fixed wings 104a and 104b.

Each of the first and second propellers 106a and 106b is a type of fan that transmits power by converting rotational motion into thrust. These propellers 106a and 106b revolve around respective rotors to keep the water helicopter 100 in flight and enable vertical ascending and descending of the same. In an embodiment, the water helicopter 100 is driven by first and second motors (not shown) which operate the first and second propellers 106a and 106b, respectively.

The design of the helicopter 100 is such that it combines the advantages of the first and second fixed wings 104a and 104b, and the first and second propellers 106a and 106b to permit normal take-off and landing procedures, as well as vertical ascent and descent as required.

As hereinabove indicated, the design of the helicopter 100 is such as to incorporate the lifting: capabilities of rotary airfoils in a manner similar to conventional helicopters while at the same time providing for a higher rate of forward airspeed. More particularly, forward and vertical thrusts are correlated whereby lift is attained as a result of such forces. Such design enables the helicopter 100 to carry a large number of people such as almost twenty without compromising on the forward airspeed.

The landing and float gear 110 enables the water helicopter 100 to land on various types of terrain and water. In accordance with an embodiment of the present disclosure, the landing and float gear 110 may be capable of supporting the helicopter 100 on various types of terrain including snow, sand and mud. In another embodiment, the landing and float gear 110 provide buoyancy for the water helicopter 100, and facilitates take-off and landing of the water helicopter 100 from and on water.

The landing and float gear 110 may be able to support the water helicopter 100 under normal landing conditions, and also under marine conditions. In another embodiment, the landing and float gear 110 can be folded and collapsed when the water helicopter 100 is in the air or on the land.

In an embodiment, the landing and float gear 110 enables the water helicopter 100 to withstand a predefined water level 112.

The water helicopter 100 can land on water in emergency situations and can pick up around twenty to twenty five people. The water helicopter 100 facilitates quicker rescue of large number of people from water bodies, and is suitable to be used by Special and Military forces.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

1. A water helicopter, comprising:
a fuselage;
first and second fixed wings extending outwardly from left and right ends of the fuselage;
first and second propellers disposed in a spaced apart configuration on a top surface of the fuselage; and
a landing and float gear attached to a bottom surface of the fuselage for enabling landing of the water helicopter on water.

2. The water helicopter as claimed in claim 1, wherein the fuselage has a door for enabling crew and passengers to enter therein.

3. The water helicopter as claimed in claim 1, wherein the first and second fixed wings generate a lift due to a forward airspeed of the water helicopter, and shapes of the first and second fixed wings.

4. The water helicopter as claimed in claim 1, wherein the first and second propellers enable vertical ascending and descending of the water helicopter.

5. The water helicopter as claimed in claim 1, wherein the landing and float gear provides buoyancy for the water helicopter and enables take-off and landing of the water helicopter from and on water.

6. The water helicopter as claimed in claim 1, wherein the landing and float gear is foldable and collapsible when the water helicopter is in the air.

7. A water helicopter, comprising:
a fuselage;
first and second fixed wings extending outwardly from left and right ends of the fuselage, wherein the first and second fixed wings generate a lift due to a forward airspeed of the water helicopter, and shapes of the first and second fixed wings;
first and second propellers disposed in a spaced apart configuration on a top surface of the fuselage, wherein the first and second propellers enable vertical ascending and descending of the water helicopter; and
a landing and float gear attached to a bottom surface of the fuselage for enabling landing of the water helicopter on water.

8. The water helicopter as claimed in claim 1, wherein the fuselage has a door for enabling crew and passengers to enter therein.

9. The water helicopter as claimed in claim 1, wherein the landing and float gear provides buoyancy for the water helicopter and enables take-off and landing of the water helicopter from and on water.

10. The water helicopter as claimed in claim 1, wherein the landing and float gear is foldable and collapsible when the water helicopter is in the air.
